(19) United States
(12) Patent Application Publication
(10) Pub. No.: US 2024/0382913 A1
(43) Pub. Date: Nov. 21, 2024

(54) STATIC MIXER ASSEMBLY FOR pH-MODIFICATION IN GEOTHERMAL POWER PLANTS

(71) Applicant: Thermochem, Inc., Santa Rosa, CA (US)

(72) Inventor: Paul Norman von Hirtz, Santa Rosa, CA (US)

(21) Appl. No.: 18/666,426

(22) Filed: May 16, 2024

Related U.S. Application Data
(60) Provisional application No. 63/467,364, filed on May 18, 2023.

(51) Int. Cl. B01F 25/435; B01F 25/431; B01F 101/00; C02F 5/08

(52) U.S. Cl. CPC B01F 25/435; B01F 25/4316; C02F 5/08; B01F 2101/305

(57) ABSTRACT

A static mixer assembly for pH-modification in geothermal power plants. The static mixer assembly includes a first tube extending along an axis, and a plurality of primary baffles extending from the first tube. The static mixer assembly further includes a second tube positioned within the first tube, and a plurality of secondary baffles extending from the second tube. An inlet tube includes a first end positioned outside the first tube and a second end positioned within the second tube.

### CROSS-REFERENCE TO RELATED APPLICATIONS

The present application claims priority to U.S. Provisional Application No. 63/467,364, filed May 18, 2023, which is incorporated herein by reference in its entirety.

### TECHNICAL FIELD

The present disclosure relates to a static mixer for the dilution and mixing of concentrated acid in water for use in, for example, a pH-modification system in geothermal power plants.

### BACKGROUND

Conventional geothermal power plants include multiple stages of flash or subcooling through Organic Rankine Cycle (ORC) heat exchangers. Heat exchangers extract heat from geothermal brine to a point where dissolved silica becomes supersaturated and will precipitate solid scale deposits in the power plant equipment, pipelines and reinjection wells.

A pH-modification (pH-mod) process inhibits scale deposition. The pH-modification process includes the injection of a concentrated acid (typically sulfuric acid or hydrochloric acid) into the geothermal brine to reduce the pH to within a range of approximately 4.5 to 5.0 pH units. See, for example, U.S. Pat. No. 4,500,434 entitled “Inhibiting scale precipitation from high temperature brine,” and U.S. Pat. No. 5,190,664 entitled “Brine heat exchanger treatment method.”

### SUMMARY

The disclosure provides, in one aspect, a static mixer assembly including a first tube extending along an axis; a plurality of primary baffles extending from the first tube; a second tube positioned within the first tube; and a plurality of secondary baffles extending from the second tube. The static mixer assembly further includes an inlet tube with a first end positioned outside the first tube and a second end positioned within the second tube.

In some embodiments, the first tube is configured to convey a brine; the inlet tube is configured to convey an acid to the second tube; and the second tube is configured to pre-mix the brine and the acid to an acid concentration less than 1% by weight. The first tube is configured to complete the mixing process, to result in a final acid concentration at the outlet of the first tube less than 0.01% by weight. The overall performance of the static mixer assembly is expressed as a Coefficient of Variance (CoV). The system is configured such that the final acid concentration at the outlet of the first tube has a CoV of less than 5%.

In some embodiments, the second tube includes an inlet portion that is funnel-shaped and positioned within the first tube.

In some embodiments, the second end of the inlet tube is positioned in the inlet portion of the second tube.

In some embodiments, the static mixer assembly further includes a support assembly connected to the first tube and configured to support the second tube within the first tube.

In some embodiments, the inlet tube is coupled to the support.

In some embodiments, the second tube is aligned with the axis.

In some embodiments, the first tube has a first length and the second tube has a second length, and wherein a ratio of the first length to the second length is within a range of 5:1 to 10:1.

In some embodiments, the inlet tube extends along an inlet axis that intersects the axis at an inlet angle.

In some embodiments, the inlet angle is within a range of 35 degrees to 55 degrees.

In some embodiments, the static mixer assembly further includes a tab positioned within the second tube.

In some embodiments, the tab includes a planar surface that extends along a plane that intersects the axis at a tab angle; wherein the tab angle is within a range of 20 degrees to 40 degrees.

In some embodiments, the inlet axis intersects the planar surface.

In some embodiments, the tab is positioned between the inlet tube and the plurality of secondary baffles.

In some embodiments, the first tube includes a high-nickel alloy, the second tube includes a tantalum, and the inlet tube includes tantalum.

In some embodiments, the first tube includes a first circular cross-section and the second tube includes a second circular cross-section.

In some embodiments, the static mixer assembly further includes a brine flowing through the first tube and an acid flowing through the inlet tube.

The disclosure provides, in one aspect, a method of reducing scale build up in a power plant. The method comprising: moving a brine through a first tube; moving a first portion of the brine through a second tube positioned within the first tube, and moving a second portion of the brine around the second tube. The method further includes injecting an acid into the second tube through an inlet tube; mixing the acid and the first portion of the brine in the second tube to create a first mixture; and mixing the first mixture exiting the second tube with the second portion of the brine in the first tube to create a second mixture.

In some embodiments, the method further includes moving the second mixture to a power plant.

In some embodiments, the acid has a density of at least 1.07 kg/L.

In some embodiments, the acid is at least 10% by weight H2SO4 or HCl.

In some embodiments, the method further includes moving the acid between an acid supply and the inlet tube with an acid supply tube, wherein the acid supply tube is a high-nickel alloy, stainless steel, or tantalum.

Other aspects of the disclosure will become apparent by consideration of the detailed description and accompanying drawings.

### BRIEF DESCRIPTION OF THE DRAWINGS

These and other features, aspects, and advantages of the present technology will become better understood with regards to the following drawings. The accompanying figures and examples are provided by way of illustration and not by way of limitation.

FIG. 1 is a schematic of a prior art system implementing a pH-modification process for a binary bottoming cycle.

FIG. 2 is a perspective view of a static mixer assembly with a pre-mixer, with an outer tube shown transparently.

FIG. 3 is a partial perspective view of a cross-section of the static mixer assembly of FIG. 2.

FIG. 4 is a partial cross-section view of the static mixer assembly of FIG. 2.

FIG. 5 is a partial perspective view of a cross-section of the static mixer assembly of FIG. 2.

FIG. 6 is a partial cross-section view of the static mixer assembly of FIG. 2.

FIG. 7 is a cross-section of the static mixer assembly of FIG. 2, illustrating a computational fluid dynamics analysis of a mass fraction of acid.

FIG. 8 is a flowchart of a method for reducing scale build up in a power plant.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language.

The term “brine,” as used herein, refers to geothermal brine (e.g., hot salty water originating underground).

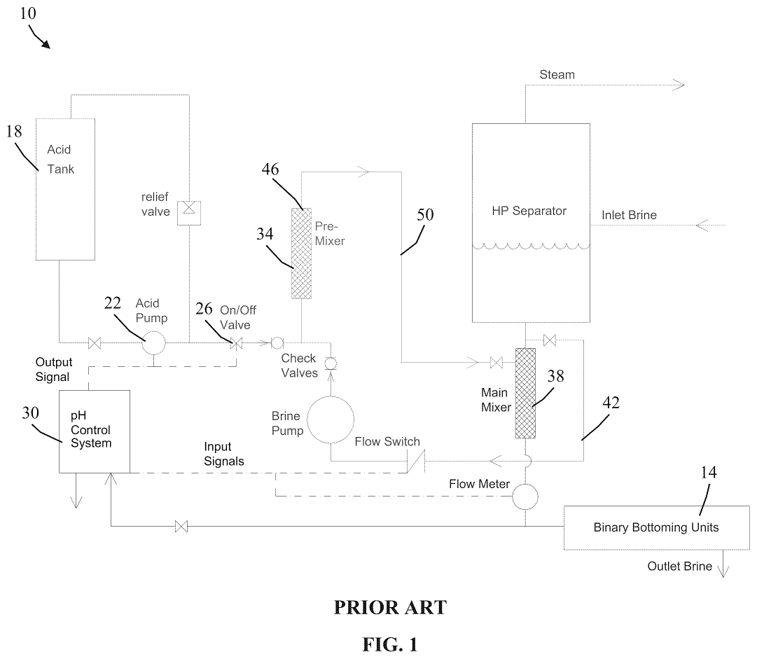

With reference to FIG. 1, a geothermal system 10 implementing a pH-modification process for geothermal brine in combination with a power plant 14 (e.g., a binary bottoming plant, an Organic Rankine Cycle (ORC), a steam flash plant, etc.). To implement the pH-modification process, the geothermal system 10 includes an acid tank 18, an acid pump 22, an acid valve 26, and a pH control system 30. The geothermal system 10 further includes a pre-mixer 34 that is separate and spaced from a main mixer 38. Conventional systems require that the acid is pre-diluted in a continuous side-stream piping system 42. The fluid used to dilute the acid is typically a side-stream of untreated geothermal brine. The acid is pre-diluted from the concentrated form (e.g., 98% solution) stored in the acid tank 18 to a dilute solution of approximately 1% at an outlet 46 of the pre-mixer 38.

The dilute acid from the pre-mixer 34 then travels through an intermediate piping system 50 before being injected where scale control is needed (e.g., upstream of ORC heat exchangers, downstream of 2^{nd}-flash vessels in a multi-stage flash plant, etc.). In FIG. 1, the dilute acid from the pre-mixer 34 travels through the intermediate piping system 50 to the main mixer 38. See “Silica Scale Control in Geothermal Bottoming Cycle Plants by pH-Modification and Thermal Quenching,” Hirtz, IIGCE, 2018, which is incorporated herein by reference in its entirety.

However, pre-dilution of concentrated acid is limited by available materials due to the corrosive nature of the hot, dilute acid. As such, the dilute acid needs to be handled in Teflon-lined or Tantalum-lined pipes, fittings and valves. For example, the intermediate piping system 50 in conventional systems is made of Teflon-lined or Tantalum-lined components. Teflon-lined and Tantalum-lined components are expensive, unreliable, have a limited life, long lead times to source, and cannot always meet the geothermal process pressure or temperature requirements. After the pre-diluted acid is injected into the main mixer 38, the diluted acid becomes mixed in the main brine stream and is no longer corrosive (pH 4.5-5.0). The main mixer 38 is typically fabricated from a high-nickel alloy (e.g., Hastelloy C-276) and cannot handle concentrated acid injection directly. However, it is not practical to line the main mixer 38 with Tantalum or Teflon due to the cost, pressure, and temperature limitations of Tantalum and Teflon.

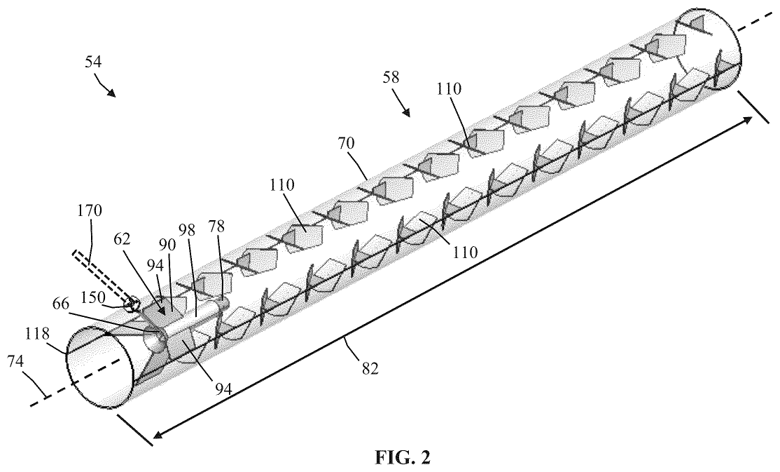

With reference to FIG. 2, a static mixer assembly 54 includes a main mixer 58 and a pre-mixer 62 positioned within the main mixer 58 (e.g., the pre-mixer 62 is “in-situ”). The static mixer assembly 54 includes the pre-mixer 62 for the pre-mixing concentrated acid with a portion of the brine and is integrated inside of the main mixer 58. The pre-mixer 62 is configured for pre-dilution of concentrated acid within the main mixer 58. As detailed further herein, concentrated acid is injected to the pre-mixer 62 through an inlet tube 66. In contrast to dilute acid, concentrated acid is not corrosive. In some embodiments, the static mixer assembly 54 is implemented in the geothermal system 10 and replaces the pre-mixer 34, the main mixer 38, the side-stream piping system 42. In the illustrated embodiment, the pre-mixer 62 is fabricated from Tantalum and is centered within the main mixer 58. In some embodiments, the inlet tube 66 is formed of Tantalum and connects externally to stainless-steel tubing that supplies the concentrated acid from the acid supply (e.g., the acid tank 18). Advantageously, the static mixer assembly 54 eliminates the need for Tantalum-lined (or Teflon-lined) piping and components for handling dilute acid (e.g., the intermediate piping system 50).

With continued reference to FIG. 2, the static mixer assembly 54 includes a first tube 70 extending along an axis 74, and a second tube 78 positioned within the first tube 70. In the illustrated embodiment, the second tube 78 is aligned with the axis 74. In other words, the second tube 78 is positioned co-axially with the first tube 70. In some embodiments, the second tube 78 is positioned offset from the axis 74. In the illustrated embodiment, a geothermal brine flows through the first tube 70. As detailed further herein, the first tube 70 is configured to convey a brine, and the second tube 78 is configured to mix a brine and an acid. In the illustrated embodiment, brine and concentrated acid are pre-mixed in the second tube 78 before being further mixed with additional brine downstream in the first tube 70.

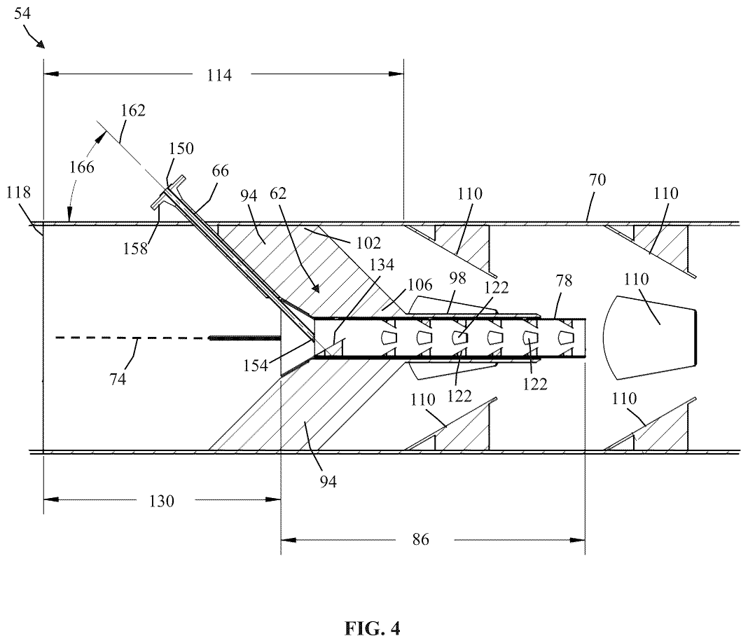

In the illustrated embodiment, the first tube 70 and the second tube 78 are circular tubes. The first tube 70 includes a first circular cross section and the second tube 78 includes a second circular cross-section. In other embodiments, the first tube or the second tube 70, 78 have non-circular cross-sections. The first tube 70 has a first length 82 (FIG. 2) and the second tube 78 has a second length 86 (FIG. 4) that is shorter than the first length 82. In some embodiments, a ratio of the first length 82 to the second length 86 is within a range of approximately 5:1 to approximately 10:1. In some embodiments, the ratio of the first length 82 to the second length 86 is within a range of approximately 5:1 to approximately 9:1.

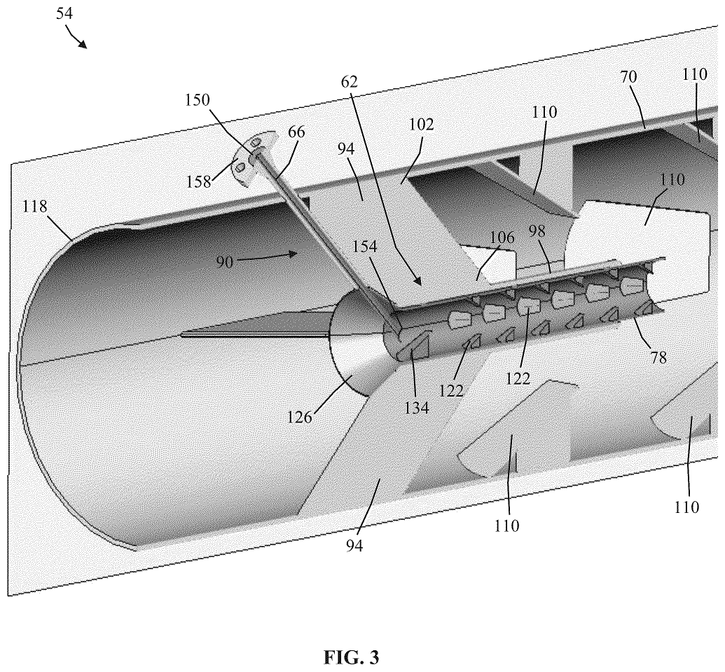

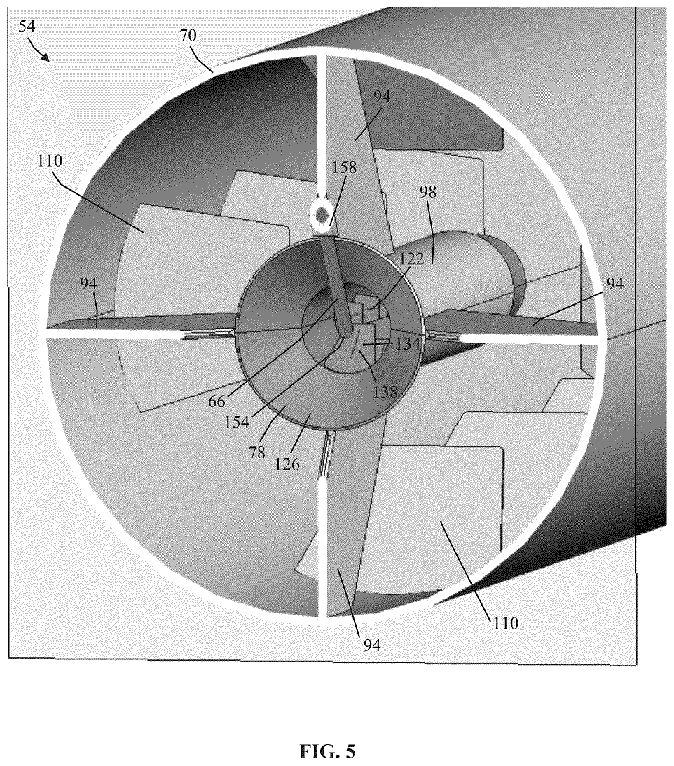

With reference to FIGS. 3 and 5, the static mixer assembly 54 further includes a support assembly 90 to position the second tube 78 within the first tube 70. In the illustrated embodiment, the support assembly 90 includes radial supports 94 and an axial collar 98. The radial supports 94 are connected to the first tube 70 at a first end 102 and connected to the axial collar 98 at a second end 106, opposite the first end 102. In the illustrated embodiment, the axial collar 98 is aligned with the axis 74 and is configured to receive the second tube 78. As such, the support assembly 90 is connected to the first tube 70 and configured to support the second tube 78 within the first tube 70. In the illustrated embodiment, radial supports 94 are positioned circumferentially around the axial collar 98 at two different axial locations along the axis 74.

With reference to FIG. 2, the static mixer assembly 54 includes a plurality of primary baffles 110 (e.g., vanes, tabs, protrusions, fins, etc.) extending from the first tube 70. In the illustrated embodiment, the primary baffles 110 extend radially inward from the first tube 70. With reference to FIG. 4, the primary baffles 110 are spaced a distance 114 from an inlet 118 of the first tube 70. In some embodiments, the main mixer 54 includes the first tube 70 and the primary baffles 110.

With reference to FIGS. 3 and 4, the static mixer assembly 54 further includes a plurality of secondary baffles 122 extending from the second tube 78. In the illustrated embodiment, the secondary baffles 122 extend radially inward from the second tube 78. The second tube 78 includes an inlet portion 126 positioned within the first tube 70. In the illustrated embodiment, the inlet portion 126 is funnel-shaped with a larger cross-section positioned upstream (e.g., toward the inlet 118 of the first tube 70). With reference to FIG. 4, the inlet portion 126 is spaced a distance 130 from the inlet 118 of the first tube 70. In the illustrated embodiment, the distance 130 is smaller than the distance 114. In other words, the primary baffles 110 are positioned downstream of the inlet 126 of the second tube 78.

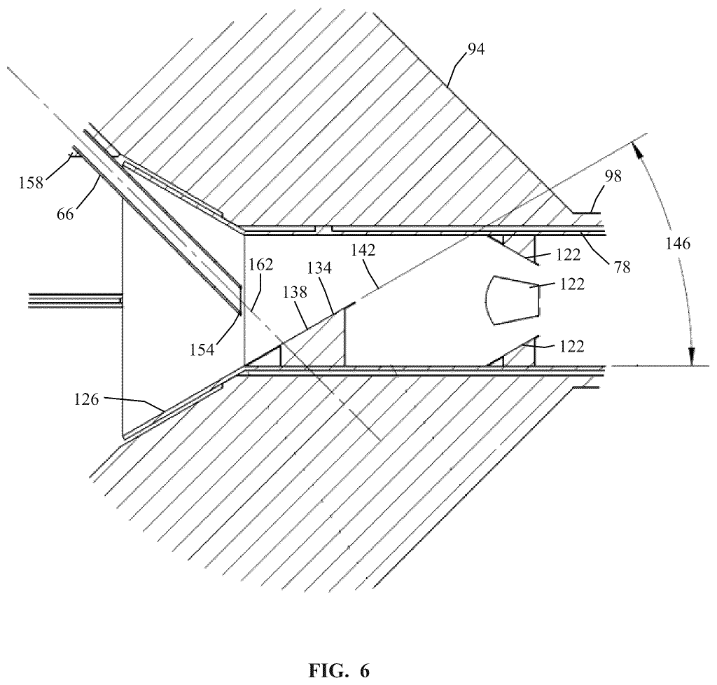

With reference to FIGS. 5 and 6, the static mixer assembly 54 further includes a tab 134 positioned within the second tube 78. The tab 134 is positioned between the inlet portion 126 and the plurality of secondary baffles 122. In the illustrated embodiment, the tab 134 includes a planar surface 138 that extends along a plane 142 that intersects the axis 74 at a tab angle 146 (FIG. 6). In some embodiments, the tab angle 146 is within a range of approximately 20 degrees to approximately 40 degrees. In the illustrated embodiment, the tab angle 146 is approximately 30 degrees. In some embodiments, the pre-mixer 62 includes the second tube 78, the secondary baffles 122, and the tab 134.

With reference to FIGS. 3 and 4, the inlet tube 66 includes a first end 150 positioned outside the first tube 70. The inlet tube 66 further includes a second end 154, opposite the first end 150, positioned within the second tube 78. In the illustrated embodiment, the inlet tube 66 is at least partially positioned within a nozzle body 158 coupled to one of the radial supports 94. As detailed further herein, the inlet tube 66 is configured to convey an acid (e.g., a concentrated acid) to the second tube 78. In other words, an acid (e.g., a concentrated acid) flows through the inlet tube 66. In the illustrated embodiment, the second end 154 of the inlet tube 66 is positioned in the inlet portion 126 of the second tube 78. In other words, the inlet tube 66 discharges concentrated acid directly upstream of the pre-mixer 62.

With continued reference to FIG. 4, the inlet tube 66 extends along an inlet axis 162. In the illustrated embodiment, the inlet axis 162 intersects the axis 74 at an inlet angle 166. In some embodiments, the inlet angle 166 is within a range of approximately 35 degrees to approximately 55 degrees. In the illustrated embodiment, the inlet angle 166 is approximately 45 degrees. In some embodiments, the inlet axis 162 intersects the planar surface 138 of the tab 134 positioned in the second tube 78. As such, the tab 134 deflects concentrated acid exiting the second end 154 of the inlet tube 66.

With reference to FIG. 2, an acid supply tube 170 is fluidly coupled to the inlet tube 66 and the acid supply tube 170 conveys concentrated acid from an acid supply (e.g., the acid tank 18). The acid supply tube 170 is a high-nickel alloy, stainless steel, or tantalum. Advantageously, the concentrated acid moving through the acid supply tube 170 is not corrosive.

In some embodiments, the first tube 70, the primary baffles 110, the support assembly 90, and the nozzle body 158 are made of a high-nickel alloy (e.g., Hastelloy C-276). In some embodiments, the second tube 78 and the inlet tube 66 are made of Tantalum. In some embodiments, pipe upstream and downstream from the static mixer assembly 54 is made of a carbon steel (e.g., ASTM A106, ASME SA106 Grade B). Advantageously, the amount of tantalum-lined components is minimized when utilizing the static mixer assembly 54, while still achieving pH-modification of the brine for a geothermal power plant.

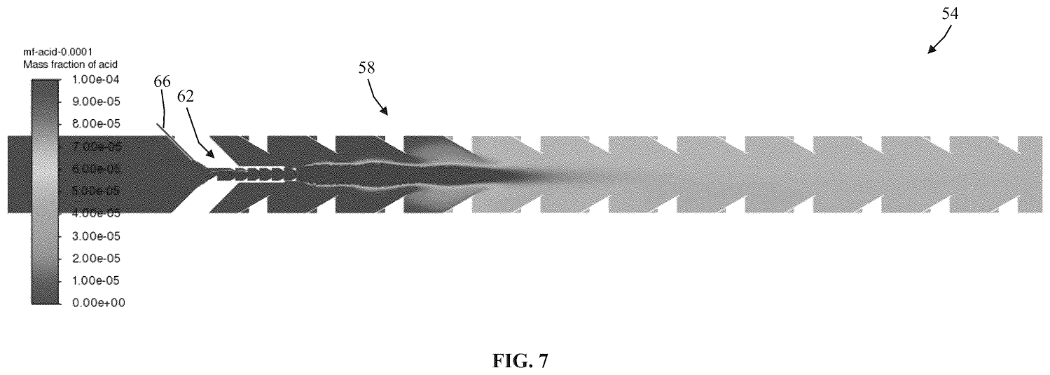

With reference to FIG. 7, a computational fluid dynamic analysis of the static mixer assembly 54 illustrates how concentrated acid injected by the inlet tube 66 into the pre-mixer 62 is pre-mixed with a portion of the brine. The pre-mixture of acid and brine exiting the pre-mixer 62 is then mixed with the remaining brine in the main mixer 58.

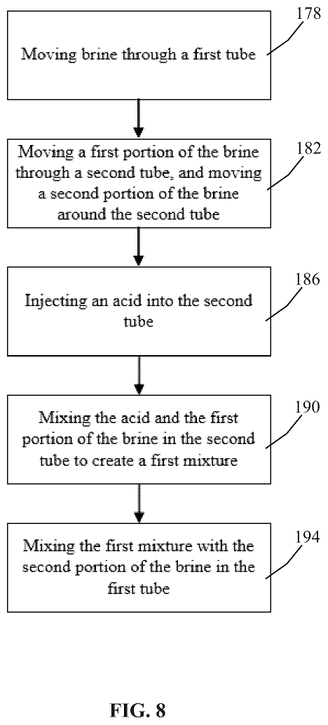

With reference to FIG. 8, a method 174 of reducing scale build up in a power plant is illustrated. The method 174 includes (STEP 178) moving a bring through a first tube. The method 174 further includes (STEP 182) moving a first portion of the brine through a second tube positioned within the first tube, and moving a second portion of the brine around the second tube. In other words, some of the brine entering the first tube flows through the second tube and the rest of the brine flows around the second tube.

The method 174 further includes (STEP 186) injecting an acid into the second tube through an inlet tube (e.g., the inlet tube 66). In some embodiments, the acid is a concentrated acid with a density of at least approximately 1.07 kg/L. In some embodiments, the acid is at least 10% by weight sulfuric acid (H2SO4) or hydrochloric acid (HCl). In some embodiments, the method 174 further includes moving the acid between an acid supply (e.g., an acid tank) and the inlet tube with an acid supply tube (e.g., acid supply tube 170). The acid supply tube is a high-nickel alloy, stainless steel, or tantalum.

The method 174 further includes (STEP 190) mixing the acid and the first portion of the brine in the second tube to create a first mixture. In other words, the acid is pre-mixed with a portion of the brine in the second tube. In some embodiments, the acid concentration leaving the second tube within a range of approximately 0.1% to approximately 1% by weight.

The method 174 further includes (STEP 194) mixing the first mixture exiting the second tube with the second portion of the brine in the first tube to create a second mixture. As such, the method 174 mixes acid in two stages. In other words, the pre-mixture leaving the second tube is mixed with the remaining portion of the brine to modify the pH of the brine exiting the first tube. In some embodiments, the method further includes moving the second mixture (pH-modified brine) to a power plant (e.g., a binary bottoming plant, an Organic Rankine Cycle (ORC), a steam flash plant, etc.).

Various features and advantages are set forth in the following claims.

What is claimed is:

1. A static mixer assembly comprising:
a first tube extending along an axis;
a plurality of primary baffles extending from the first tube;
a second tube positioned within the first tube;
a plurality of secondary baffles extending from the second tube; and
an inlet tube with a first end positioned outside the first tube and a second end positioned within the second tube.

2. The static mixer assembly of claim 1, wherein the first tube is configured to convey a brine; wherein the inlet tube is configured to convey an acid to the second tube; and wherein the second tube is configured to mix the brine and the acid.

3. The static mixer assembly of claim 1, wherein the second tube includes an inlet portion that is funnel-shaped and positioned within the first tube.

4. The static mixer assembly of claim 3, wherein the second end of the inlet tube is positioned in the inlet portion of the second tube.

5. The static mixer assembly of claim 1, further comprising a support assembly connected to the first tube and configured to support the second tube within the first tube.

6. The static mixer assembly of claim 5, wherein the inlet tube is coupled to the support.

7. The static mixer assembly of claim 1, wherein the second tube is aligned with the axis.

8. The static mixer assembly of claim 1, wherein the first tube has a first length and the second tube has a second length, and wherein a ratio of the first length to the second length is within a range of 5:1 to 10:1.

9. The static mixer assembly of claim 1, wherein the inlet tube extends along an inlet axis that intersects the axis at an inlet angle.

10. The static mixer assembly of claim 9, wherein the inlet angle is within a range of 35 degrees to 55 degrees.

11. The static mixer assembly of claim 1, further comprising a tab positioned within the second tube.

12. The static mixer assembly of claim 11, wherein the tab includes a planar surface that extends along a plane that intersects the axis at a tab angle; wherein the tab angle is within a range of 20 degrees to 40 degrees.

13. The static mixer assembly of claim 12, wherein inlet axis intersects the planar surface.

14. The static mixer assembly of claim 11, wherein the tab is positioned between the inlet tube and the plurality of secondary baffles.

15. The static mixer assembly of claim 1, wherein the first tube includes a high-nickel alloy, the second tube includes a tantalum, and the inlet tube includes tantalum.

16. The static mixer assembly of claim 1, wherein the first tube includes a first circular cross-section and the second tube includes a second circular cross-section.

17. The static mixer assembly of claim 1, further including a brine flowing through the first tube and an acid flowing through the inlet tube.

18. A method of reducing scale build up in a power plant, the method comprising:
moving a brine through a first tube;
moving a first portion of the brine through a second tube positioned within the first tube, and moving a second portion of the brine around the second tube;
injecting an acid into the second tube through an inlet tube;
mixing the acid and the first portion of the brine in the second tube to create a first mixture; and
mixing the first mixture exiting the second tube with the second portion of the brine in the first tube to create a second mixture.

19. The method of claim 18, further comprising moving the second mixture to a power plant.

20. The method of claim 18, wherein the acid has a density of at least 1.07 kg/L.

21. The method of claim 18, wherein the acid is at least 10% by weight H2SO4 or HCl.

22. The method of claim 18, further comprising moving the acid between an acid supply and the inlet tube with an acid supply tube, wherein the acid supply tube is a high-nickel alloy, stainless steel, or tantalum.
